(19) United States
(12) Patent Application Publication
(10) Pub. No.: US 2018/0216956 A1
(43) Pub. Date: Aug. 2, 2018

(54) LOCATION-BASED GENERATION OF MULTIMEDIA CONTENT

(71) Applicant: Sandra Ritcherson, Atlanta, GA (US)

(72) Inventor: Sandra Ritcherson, Atlanta, GA (US)

(21) Appl. No.: 15/885,406

(22) Filed: Jan. 31, 2018

Related U.S. Application Data
(60) Provisional application No. 62/452,739, filed on Jan. 31, 2017.

(51) Int. Cl. G01C 21/36

(52) U.S. Cl. CPC G01C 21/3682; G01C 21/3688; G01C 21/3697

(57) ABSTRACT

One or more embodiments described herein can provide for location-based generation of multimedia content. In some embodiments a system comprises: a first generation component configured to generate a first set of multimedia content corresponding to a first location of a vehicle; a second generation component configured to generate a second set of multimedia content corresponding to a second location of the vehicle; an interaction component configured to facilitate generation of detailed information associated with a first subset of multimedia content of the first set of multimedia content or a second subset of multimedia content of the second set of multimedia content based on a set of received input data; and a presentation component configured to display the first set of multimedia content, the second set of multimedia content, the first subset of multimedia content or the second subset of multimedia content at a user interface.

### CROSS-REFERENCE TO RELATED APPLICATION

This application claims priority to U.S. Provisional Application Ser. No. 62/452,739, filed Jan. 31, 2017, and titled, “COMPUTER-BASED SYSTEMS, COMPUTER READABLE STORAGE MEDIA AND METHODS FOR AUTOMATED GENERATION OF MEDIA CONTENT ASSOCIATED WITH TRANSPORTATION TOURS,” the entirety of which is incorporated herein by reference.

### TECHNICAL FIELD

This disclosure generally relates to methods, computer readable storage media and computer-based systems associated with location-based generation of multimedia content.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to facilitating location-based generation of multimedia content. In various embodiment, the multimedia content can encompass and/or be associated with travel and tourism. In an aspect, disclosed is a non-limiting example embodiment of a system comprising a first generation component, a second generation component, an interaction component, and a presentation component. In an aspect, first generation component is configured to generate a first set of multimedia content corresponding to a first location of a vehicle. In another aspect, second generation component is configured to generate a second set of multimedia content corresponding to a second location of the vehicle.

Also, in an aspect, interaction component is configured to facilitate generation of detailed information associated with a first subset of multimedia content of the first set of multimedia content or a second subset of multimedia content of the second set of multimedia content based on a set of received input data. In yet another aspect, presentation component is configured to display the first set of multimedia content, the second set of multimedia content, the first subset of multimedia content or the second subset of multimedia content at a user interface.

Also disclosed is a non-limiting example method of generating multimedia content associated with travel and tourism. In an aspect, the method comprises generating, by a system comprising a processor, a first set of multimedia content corresponding to a first location of a vehicle. The method further comprises generating, by the system, a second set of multimedia content corresponding to a second location of the vehicle. Also, the method comprises facilitating, by the system, generation of detailed information associated with a first subset of multimedia content of the first set of multimedia content or a second subset of multimedia content of the second set of multimedia content based on a set of received input data. In yet another aspect, the method comprises displaying, by the system, the first set of multimedia content, the second set of multimedia content, the first subset of multimedia content or the second subset of multimedia content at a user interface.

Also disclosed is another non-limiting example method of generating multimedia content associated with travel and tourism. In an aspect, a computer-implemented method comprises: generating, by a system comprising a processor, a first set of multimedia content corresponding to a historical or natural landmark of interest within a defined proximity to a location of a vehicle; and displaying, by a user interface of the system, the first set of multimedia content, wherein the displaying comprises outputting video of images and textual details regarding the historical or natural landmark of interest, and wherein the displaying is output during a time period overlapping with a second time period during which the location of the vehicle is within the defined proximity to the historical or natural landmark of interest.

Also disclosed is a non-limiting aspect of a machine-readable storage medium, comprising executable instructions that, when executed by a processor, facilitate performance of operations, comprising: generating a first set of multimedia content corresponding to a first location of a vehicle; generating a second set of multimedia content corresponding to a second location of the vehicle; facilitating generation of detailed information associated with a first subset of multimedia content of the first set of multimedia content or a second subset of multimedia content of the second set of multimedia content based on a set of received input data; and displaying the first set of multimedia content, the second set of multimedia content, the first subset of multimedia content or the second subset of multimedia content at a user interface.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a non-limiting, example block diagram of an example system embodiment that can facilitate automated generation of multimedia content associated with tourism and travel in one or more embodiments;

FIG. 2 illustrates a non-limiting, example block diagram of an example system embodiment that can facilitate automated generation of multimedia content associated with tourism and travel in one or more embodiments;

FIG. 3 illustrates a non-limiting, example block diagram of an example system embodiment that can facilitate automated generation of multimedia content associated with tourism and travel in one or more embodiments;

FIG. 4 illustrates a non-limiting, example block diagram of an example system embodiment that can facilitate automated generation of multimedia content associated with tourism and travel in one or more embodiments;

FIG. 5 illustrates a non-limiting example of a method for facilitating automated generation of multimedia content associated with tourism and travel in one or more embodiments;

FIG. 6 illustrates a non-limiting example of a method for facilitating automated generation of multimedia content associated with tourism and travel in one or more embodiments;

FIG. 7 illustrates a non-limiting example of a method for facilitating automated generation of multimedia content associated with tourism and travel in one or more embodiments;

FIG. 8 illustrates an example schematic block diagram for a computing environment in accordance with certain embodiments of this disclosure;

FIG. 9 illustrates an example block diagram of a computer operable to execute certain embodiments of this disclosure; and

FIG. 10 illustrates a block diagram of a computer operable to facilitate generation of multimedia content systems in accordance with one or more embodiments described herein.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing this disclosure.

In implementations, the components described herein can perform actions, in real-time, near real-time, online and/or offline. Online/offline can refer to states identifying connectivity between one or more components. In general, “online” indicates a state of connectivity, while “offline” indicates a disconnected state. In an aspect, offline merging can prevent service interruptions, end-user quality degradation, and the like.

While the various components are illustrated as separate components, it is noted that the various components can be comprised of one or more other components. Further, it is noted that the embodiments can comprise additional components not shown for sake of brevity. Additionally, various aspects described herein may be performed by one device or two or more devices in communication with each other. It is noted that while media items are referred to herein, the systems and methods of this disclosure can utilize other content items.

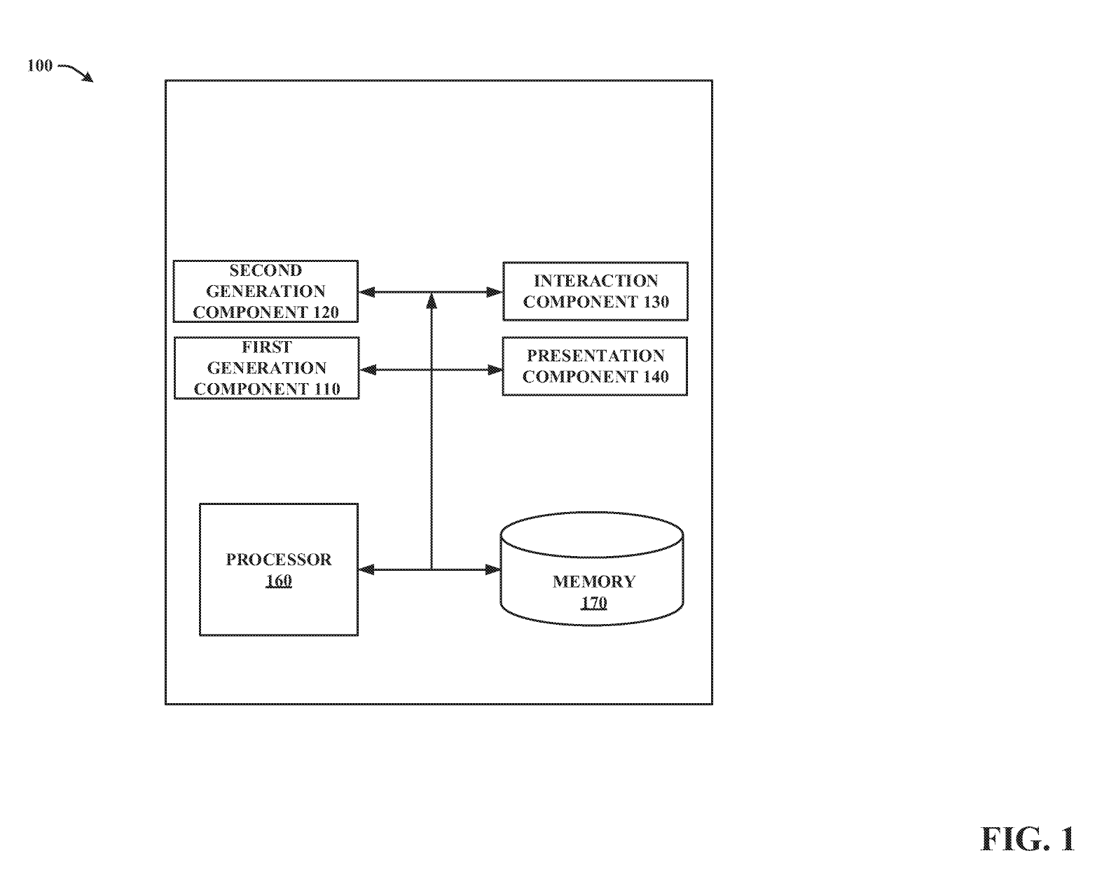

Referring now to FIG. 1, presented is an example system 100 configured to facilitate automated generation of multimedia content associated with tourism and travel in one or more embodiments. The various components of system 100 and other systems described herein can be connected either directly or indirectly to one or more networks. In an aspect, system 100 can comprise first generation component 110, second generation component 120, interaction component 130, and presentation component 140. In an aspect, a system 100 can further comprise a processor 160 and can also include memory 170 that stores computer executable components, and a processor 160 executes the computer executable components stored in the memory 170.

For example, first generation component 110 employed by system 100 can be stored in memory 170 and executed (e.g. using processor 160) to generate a first set of multimedia content corresponding to a first location of a vehicle. In an aspect, disclosed is system 100 that automatically generates multimedia content in association with locations associated with travel or tourism. For instance, first generation component 110 can receive and/or access data associated with a location of a vehicle (e.g., plane, bus, car, boat, etc.). Furthermore, generation component 110 can receive location data corresponding to landmarks, terrain (e.g., mountains, rivers, waterways, etc.), and points of interest within a proximity of the vehicle location. Accordingly, first generation component 110 can generate multimedia content based on the received location data, where the multimedia content can represent information, subject matter, and/or content corresponding to the points of interest.

Thus, first generation component 110 can generate text, audio recordings, images, video and/or cartoon content corresponding to the point of interest for output at a user interface (e.g., using presentation component 140). The images can also include information such as two dimensional renderings or three dimensional renderings that can be viewed employing three dimensional glasses. For instance, an airplane may be flying over a monument such as mount Rushmore. As such, first generation component 110 can receive location data indicating the plane is in close proximity to mount Rushmore and generate images, pictures, history, details of the carvings, the process of formalizing the moment, videos of the biographies of the presidents on mount Rushmore, and other such content associated with that landmark. In some embodiments, the system can include a camera (not shown) that can be employed to film and/or photography real-time images or video of the location of interest. For example, the camera can be communicatively coupled to the presentation component 140 and information retrieved by camera can be streamed and/or otherwise transmitted to the presentation component 140 for display and/or output.

In another aspect, system 100 can employ second generation component 120 that is configured to generate a second set of multimedia content corresponding to a second location of the vehicle. Accordingly, second generation component 120 can receive location data that indicates the vehicle has moved to a different geographic location. As such, based on such received input, second generation component 120 can generate a second set of multimedia content associated with points of interest in close proximity to the location associated with the received location data. Thus, between first generation component 110 and second generation component 120, system 100 can recurrently generate multimedia content associated with various points of interest as a vehicle is traveling along various locations. This generation by first generation component 110 and second generation component 120 can be generated based on received input such as location data, map data, navigation data, user input data, and other such data input sources.

Also, in an aspect, system 100 can employ interaction component 130 configured to facilitate generation of detailed information associated with a first subset of multimedia content of the first set of multimedia content or a second subset of multimedia content of the second set of multimedia content based on a set of received input data. In an aspect, interaction component 130 can generate specific and detailed information corresponding to a point of interest based on received user input. For instance, where first generation component 110 generates a set of data associated with the Panama Canal based on received data that indicates the vehicle is in proximity to the Panama Canal, the interaction component 130 can receive user input associated with details corresponding to the Panama Canal.

For instance, a user interface can present (e.g., using presentation component 140) information about the Panama Canal and based on such information the user interface can receive data prompting system 100 to present more information about the Panama Canal, such as the cost of the structure, the historical context of building the canal, the economic implications associated with its being built, and other such information. The detailed information can be generated based on user input and the data can indicate the type of multimedia content sought (e.g., video, audio, images, text, etc.), the context of the content (e.g., history, business, politics, etc.), and other such variables to present (e.g., using presentation component 140) the particular content desired as per the received user input.

In another aspect, system 100 can employ presentation component 140 configured to display the first set of multimedia content, the second set of multimedia content, the first subset of multimedia content or the second subset of multimedia content at a user interface. In an aspect, the multimedia content generated by first generation component 110, second generation component 120, and interaction component 130 can be displayed using presentation component 140. The multimedia content can be displayed on screens affixed to the vehicle or user devices (e.g., mobile phones, tablets, computers, overhead screens, displays affixed to seats etc.). Furthermore, in an aspect, audio multimedia content can be presented (e.g., using presentation component 140) via headphone jacks, vehicle speaker systems, or other audio output mechanisms. Also, in an aspect, the user interface can receive data by detecting user interactions with the user interface (e.g., touch, pressing buttons, voice activation, etc.). Furthermore, the interface can present a variety of visualizations to prompt generation of multimedia content. For instance, the interface can present an interactive map, interactive text, interactive images, interactive video, interactive search box and other such interfaces.

In some embodiments, the first set of multimedia content, second set of multimedia content, first subset of multimedia content and/or second subset of multimedia content can be displayed automatically based on detection that the vehicle is in a particular location in proximity to the location of interest/landmark that the multimedia content is about. New multimedia content can be automatically output replacing or supplementing previous multimedia content as the vehicle moves to pass one location of interest/landmark to another location of interest/landmark (as determined by GPS or other vehicle tracking). In some embodiments, the multimedia content display/output can be altered or controlled by a user of a user interface (the user can enter an input received at the system that causes the system to either slow the pace of multimedia content display/output, speed the pace, move on to another display about the same or a different past or present landmark on the tour (or an otherwise related landmark or location of interest that is not on the tour). In some embodiments, the system can receive a user input causes the system to scroll through one or more displays, in some cases, before the vehicle has left the proximity of the current location/landmark of interest.

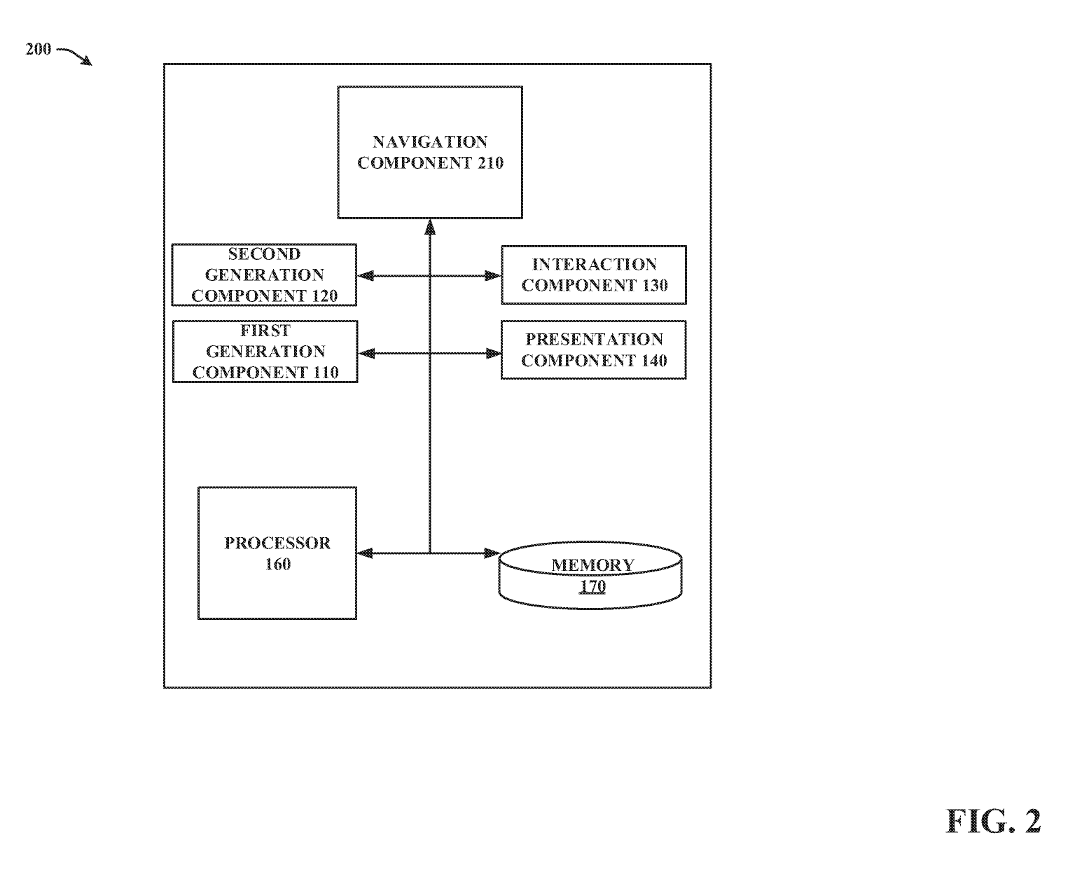

Referring to FIG. 2, illustrated is non-limiting example system 200 configured to facilitate automated generation of multimedia content associated with tourism and travel in one or more embodiments. System 200 can comprise first generation component 110, second generation component 120, interaction component 130, and presentation component 140. System 200 can further comprise navigation component 210 configured to generate the first subset of multimedia content or the second set of multimedia content based on global positioning coordinates of the vehicle in connection with a vehicle map navigation tool. In an aspect, first generation component 110 and second generation component 120 can generate the multimedia content based on location data. The location data can be received from navigation component 210 which draws location data from the vehicles existing navigation systems such as global positioning systems, flight mapping systems, boat navigation systems, Doppler systems, radar systems, and other such mapping systems.

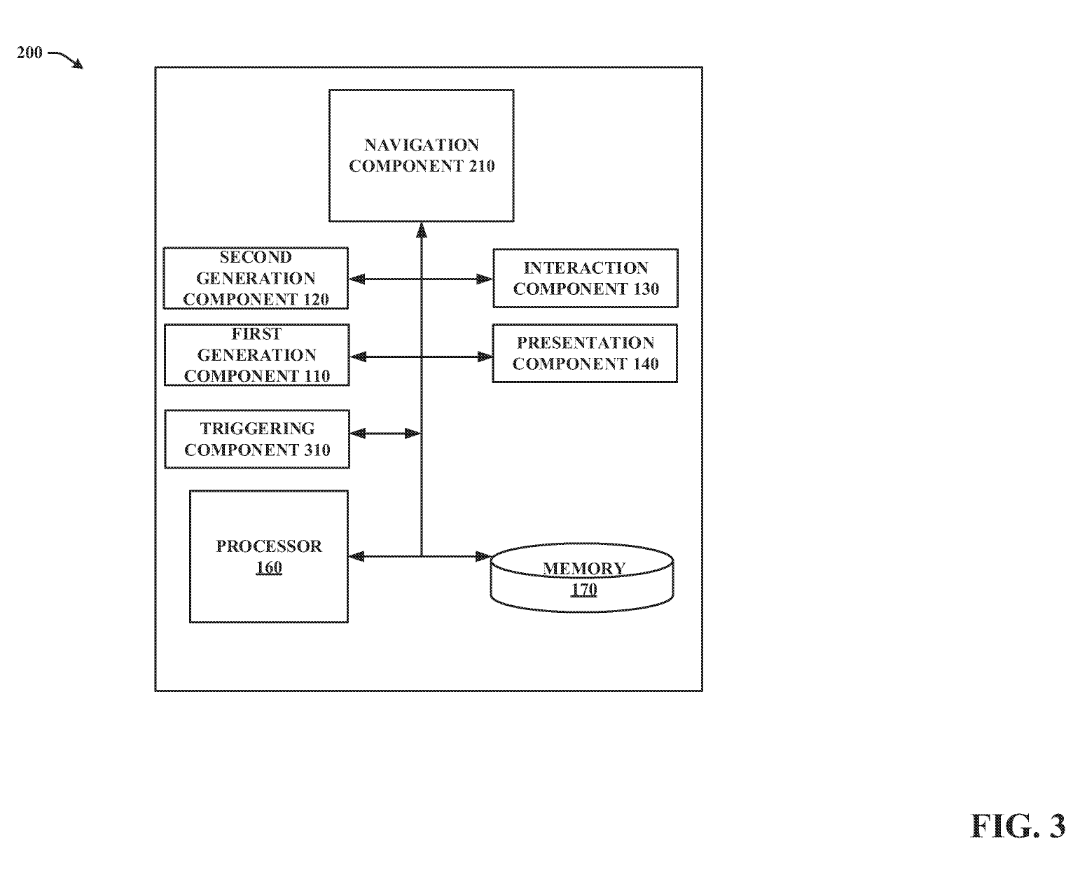

Referring to FIG. 3, illustrated is non-limiting example system 300 configured to facilitate automated generation of multimedia content associated with tourism and travel in one or more embodiments. System 300 can comprise first generation component 110, second generation component 120, interaction component 130, presentation component 140, and navigation component 210. System 300 can further comprise a triggering component 310 configured to automatically present the first set of multimedia content or the second set of multimedia content based on the vehicle proximity to a point of interest. In an aspect, triggering component 310 can automatically present prioritized information (e.g., using presentation component 140) based on received location data, ranking data, scoring data, popularity data, user selection data, and other such indicia that identifies particular multimedia content to present based on proximity to a point of interest. For interest, first generation component 110 can generate multimedia content based on receiving location data of the vehicles proximity to Washington D.C. Accordingly, triggering component 310 can automatically present (in connection with presentation component 140) multimedia content associated with the White House rather than other Washington D.C. based monuments based on score data, ranking data or popularity data that indicates the White House is the most desired point of interest to learn about.

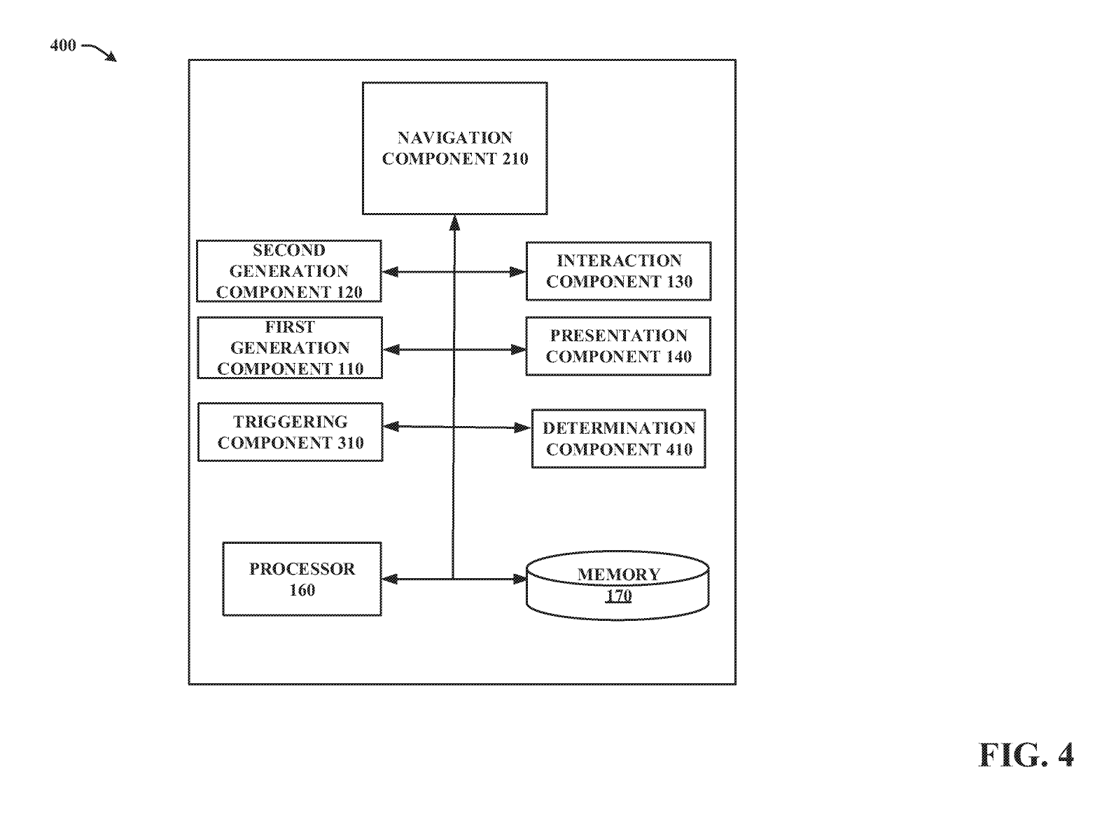

Referring to FIG. 4, illustrated is non-limiting example system 400 configured to facilitate automated generation of multimedia content associated with tourism and travel in one or more embodiments. System 400 can comprise first generation component 110, second generation component 120, interaction component 130, presentation component 140, navigation component 210, and triggering component 310. In another aspect, system 300 can further comprise determination component 410 configured to determine the vehicle proximity to the point of interest based on the global positioning coordinates. In an aspect, determination component 410 can utilize received location data to determine the vehicle proximity to points of interest. As such, determination component 410 can use data from sources such as global positioning satellites and perform calculations to determine the point of interests closes to the vehicle. Furthermore, determination component 410 can account for other variables (e.g., popularity indicators, ranking variables, demographic information of passengers, etc.) to calculate the closest and most popular points of interests.

In various embodiments, computer program products having computer-readable mediums comprising code can be utilized to perform any of the methods and execute any of the system components described herein. The systems 100, 200, 300, and 400, and/or the components of the systems 100, 200, 300, and 400 can be employed to use hardware and/or software to solve problems that are highly technical in nature (e.g., related to synchronizing global positioning of vehicles, incorporating preferences and generating tactile or other type of display; artificial intelligence, automation, determination, generation, presentation etc.), that are not abstract and that cannot be performed as a set of mental acts by a human. Further, some of the processes performed may be performed by specialized computers for carrying out defined tasks related to the automatic generation of multimedia content associated with location data. The systems 100, 200, 300, and 400 and/or components of the systems can be employed to solve new problems that arise through advancements in technology, computer networks, the Internet and the like. The systems 100, 200, 300, and 400 can provide technical improvements to location-based data systems by improving the generation of multimedia content associated with points of interest, the recurring generation of multimedia content based on changing location data, the calculation of desired multimedia associated with a particular location based on various data sets, etc. One or more of systems 100, 200, 300, 400 can include or have the structure and/or functionality of one or more aspects of other ones of systems 100, 200, 300, 400 or vice versa.

One or more embodiments can result in computer technological improvement, and embodiments that can be manifested in the physical world (tactile display based on system operation; direction of a vehicle to change course in the physical world based on information processed and/or preferences). Thus, the embodiments described herein can result in effects or changes in the actual physical world in some embodiments.

Technological improvements to the computer (e.g., processor of the system) can be provided based on one or more embodiments herein. In some embodiments, the efficiency of using the system (which can be an electronic device) can be improved by (in embodiments in which the user can control the pace of the subject matter displayed) bringing together a list of common functions and commonly accessed stored multimedia content provided and accessed directly from a main menu in some embodiments. Accordingly, by displaying such information from the main menu, the selected multimedia content or functions of interest can allow the user to see the most relevant multimedia data or functions without actually opening an application executing on the device coupled to the user interface and/or searching through the same. The speed of a user's navigation through various views and windows can be improved because the user is prevented from having to navigate to a required application, opening the application and then navigating within that application to enable the multimedia content of interest to be seen or a function of interest to be activated. This results in less processing time for the computer and processor of the computer and less utilization of memory. For example, text and images for a same or different location of interest or landmark can be accessible from a single main menu or screen of the user interface. As another example, the computer can determine that a particular location of interest is usually selected for display (by a user or automatically by the system) within a defined amount of time after a first particular location of interest is displayed or selected for display (the selection can be based on user preference or based on historical information). Information about these two locations can be determined to have a defined correlation that is greater than a particular threshold and therefore the information for the locations can be displayed together or accessible from a single main menu of the user interface. As noted, the user interface can be interactive in some embodiments and can receive one or more inputs that are selections for display of information via the user interface.

Thus one or more embodiments can provide an improvement in the functioning and capability of computers, particularly those with small screens such as can be employed in one or more embodiments herein screens (e.g., for embodiments herein for smart phones, smart watches and the like) and the embodiments are not abstract. Thus, software improvements to the technology herein can result in improved usability for the user (e.g. efficiency of use, improved speed of navigation, reduced user steps, etc.).

In some embodiments, the image or video can be generated within a defined time of approaching an area of the location of interest based on retrieval from a database, a camera taking a picture of the area, a video camera recording video of the area (either prestored video or video recorded in real-time or within a defined number of minutes (10 seconds-3 minutes) upon approaching a defined area that is in proximity to the location of interest). The image or video can be displayed via the user interface.

In some embodiments, information regarding or identifying the location of interest can be provided to a navigation system associated with the vehicle and can output a command or information for the vehicle to take a particular path to traverse an area associated with the location of interest or another location of interest (which can be a location of interest that has a defined correlation with the first location of interest). The correlation can be based on proximity to one another, similarity in topic or theme to one another, past or current user interest in both locations of interest at least meeting or exceeding a defined threshold.

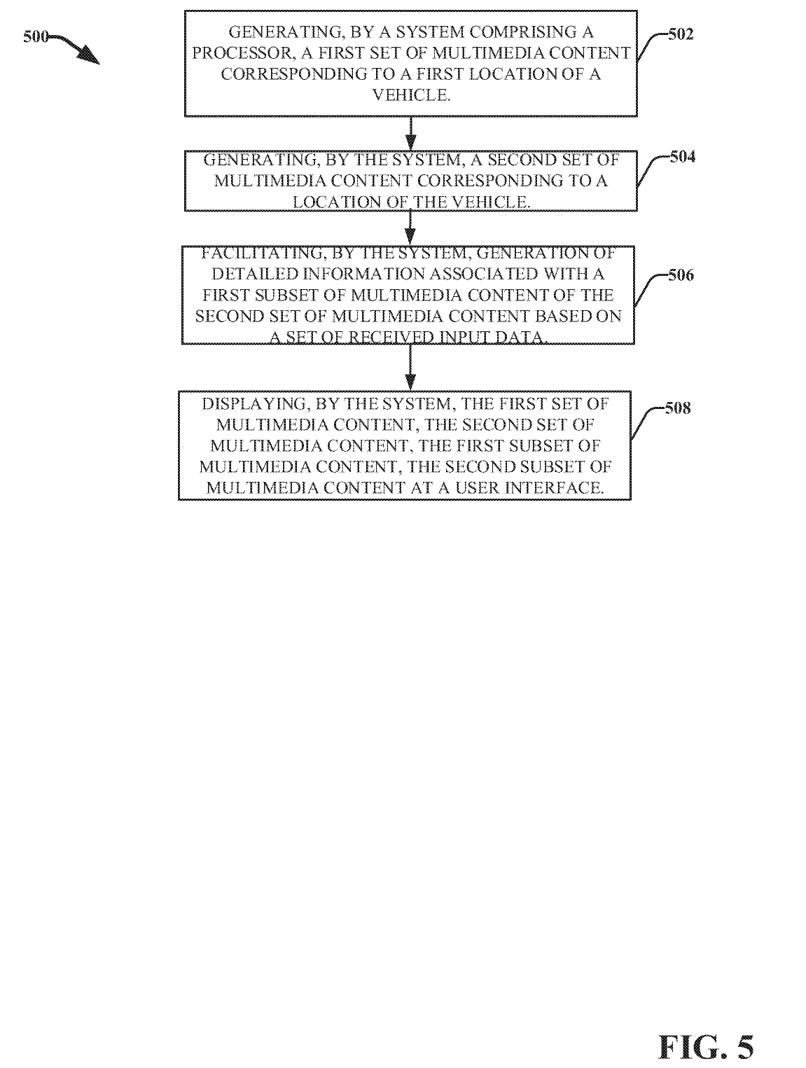

In view of the example systems/interfaces described herein, example methods that can be implemented in accordance with the disclosed subject matter can be further appreciated with reference to flowcharts in FIGS. 5, 6, and 7. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 5 illustrates a flow chart of an example method 500 for facilitating automated generation of multimedia content associated with tourism and travel in one or more embodiments. At 502, a first set of multimedia content is generated (e.g., using first generation component 110) corresponding to a first location of a vehicle. At 504, a second set of multimedia content is generated (e.g., using second generation component 120) corresponding to a second location of the vehicle. At 506, detailed information is generated (e.g., using interaction component 130) associated with a first subset of multimedia content of the first set of multimedia content or a second subset of multimedia content of the second set of multimedia content based on a set of received input data. At 508, the first set of multimedia content, the second set of multimedia content, the first subset of multimedia content or the second subset of multimedia content is displayed (e.g., using presentation component 140) at a user interface.

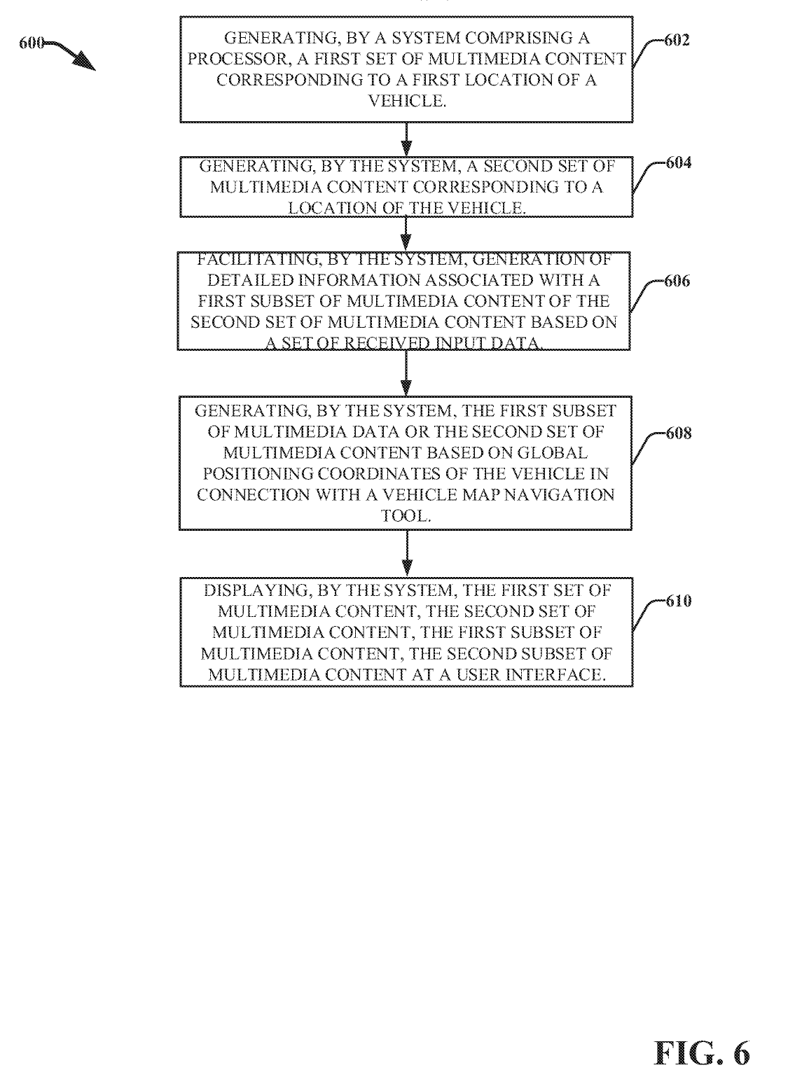

FIG. 6 illustrates a flow chart of an example method 600 for facilitating automated generation of multimedia content associated with tourism and travel in one or more embodiments. At 602, a first set of multimedia content is generated (e.g., using first generation component 110) corresponding to a first location of a vehicle. At 604, a second set of multimedia content is generated (e.g., using second generation component 120) corresponding to a second location of the vehicle. At 606, detailed information is generated (e.g., using interaction component 130) associated with a first subset of multimedia content of the first set of multimedia content or a second subset of multimedia content of the second set of multimedia content based on a set of received input data. At 608, the first set of multimedia content, the second set of multimedia content, the first subset of multimedia content or the second subset of multimedia content is displayed (e.g., using presentation component 140) at a user interface. At 610, the first subset of multimedia content or the second set of multimedia content is generated (e.g., using navigation component 610) based on global positioning coordinates of the vehicle in connection with a vehicle map navigation tool.

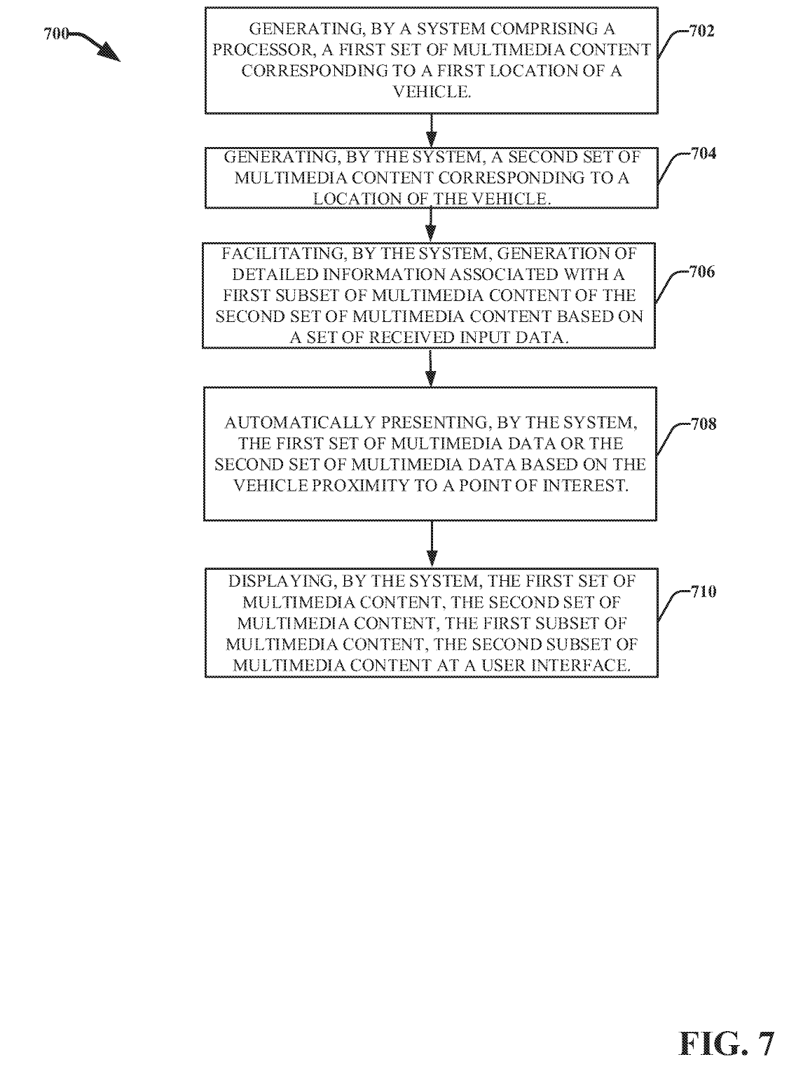

FIG. 7 illustrates a flow chart of an example method 700 for facilitating automated generation of multimedia content associated with tourism and travel in one or more embodiments. At 702, a first set of multimedia content is generated (e.g., using first generation component 110) corresponding to a first location of a vehicle. At 704, a second set of multimedia content is generated (e.g., using second generation component 120) corresponding to a second location of the vehicle. At 706, detailed information is generated (e.g., using interaction component 130) associated with a first subset of multimedia content of the first set of multimedia content or a second subset of multimedia content of the second set of multimedia content based on a set of received input data. At 708, the first set of multimedia content or the second set of multimedia content is presented (e.g., using triggering component 310) based on the vehicle proximity to a point of interest. At 710, the first set of multimedia content, the second set of multimedia content, the first subset of multimedia content or the second subset of multimedia content is displayed (e.g., using presentation component 140) at a user interface.

Various embodiments are described herein. In one embodiment, a system comprises: a memory that has stored thereon computer executable components; and a processor that executes the computer executable components stored in the memory. In one or more embodiments, the computer executable components can comprise: a first generation component configured to generate a first set of multimedia content corresponding to a first location of a vehicle; a second generation component configured to generate a second set of multimedia content corresponding to a second location of the vehicle; an interaction component configured to facilitate generation of detailed information associated with a first subset of multimedia content of the first set of multimedia content or a second subset of multimedia content of the second set of multimedia content based on a set of received input data; and a presentation component configured to display the first set of multimedia content, the second set of multimedia content, the first subset of multimedia content or the second subset of multimedia content at a user interface.

In some embodiments, the computer executable components further comprise a navigation component configured to generate the first subset of multimedia content or the second set of multimedia content based on global positioning coordinates of the vehicle, wherein the navigation component interacts with and receives information from a vehicle map navigation tool. In some embodiments, the computer executable components further comprise a triggering component configured to automatically present the first set of multimedia content or the second set of multimedia content based on the vehicle proximity to a point of interest.

In some embodiments, the computer executable components further comprise a determination component configured to determine the vehicle proximity to the point of interest based on the global positioning coordinates.

In some embodiments, the first set of multimedia content or the second set of multimedia content comprises at least one of audio content, image content, or video content. In some embodiments, the point of interest comprises at least one of a waterway, a river, a landmark, a monument, a historical event, or an identified terrain. In various embodiments, the vehicle can be or comprise an airplane (or any flying vehicle, such as a helicopter, drone or the like), a train (whether above ground or below ground as a subway), a boat or a street vehicle, including, but not limited to, a bus or a car. In some embodiments, the user interface is coupled to at least one of a mobile device, a tablet device or the vehicle.

In some embodiments, the first subset of multimedia content or the second subset of multimedia content is detailed information about the point of interest. The detailed information comprises at least one of an image of the point of interest, a photograph of the point of interest, textual information about the point of interest, video information about the point of interest or audio information about the point of interest.

In another embodiment, a method (not shown) can be provided. The computer-implemented method can comprise: generating, by a system comprising a processor, a first set of multimedia content corresponding to a historical or natural landmark of interest within a defined proximity to a location of a vehicle; and displaying, by a user interface of the system, the first set of multimedia content, wherein the displaying comprises outputting video of images and textual details regarding the historical or natural landmark of interest, and wherein the displaying is output during a time period overlapping with a second time period during which the location of the vehicle is within the defined proximity to the historical or natural landmark of interest.

In some embodiments, the computer-implemented method can further comprise: receiving, by the system, global positioning coordinates of the location of the vehicle; and identifying, by the system, the historical or natural landmark of interest and generating, by the system, the first set of multimedia content based on the location of the vehicle.

In some embodiments, the computer-implemented method further comprises: generating, by the device, information indicative of instructions to enable the vehicle to navigate to a second historical or natural landmark of interest based on a determination by the system that the historical or natural landmark of interest is associated with the second historical or natural landmark of interest.

In some embodiments, the computer-implemented method further comprises: generating, by the device, information indicative of instructions to enable the vehicle to navigate to a second historical or natural landmark of interest based on a determination by the system that the historical or natural landmark of interest has been determined to be related based on an input of a user.

In some embodiments, a machine-readable storage medium, comprising executable instructions that, when executed by a processor, facilitate performance of operations is provided. The operations can comprise: generating a first set of multimedia content corresponding to a first location of a vehicle; generating a second set of multimedia content corresponding to a second location of the vehicle; facilitating generation of detailed information associated with a first subset of multimedia content of the first set of multimedia content or a second subset of multimedia content of the second set of multimedia content based on a set of received input data; and displaying the first set of multimedia content, the second set of multimedia content, the first subset of multimedia content or the second subset of multimedia content at a user interface.

In some embodiments, the displaying comprising providing tactile display via the user interface. In some embodiments, the vehicle comprises an airplane

As used herein, the term “display” can be or include outputting information in any manner including, but not limited to, audio output, image output, video output, tactile output or the like. By way of example, but not limitation, tactile output can be or include output causing the user interface to shake or move, for example. In one embodiment, the user interface can be malleable and/or able to deform and therefore the output can be a tactile output that takes one or more three-dimensional shapes that can change over time (and/or dynamically takes the shape of braille words/letters for enabling a visually-impaired user to read). This can allow seeing and vision-impaired users (as well as hearing and hearing-impaired users) can experience the location of landmark of interest by feeling a recreation of at least a portion of the image (while possibly also hearing audio output). More than one type of output can be provided from the user interface at any particular time and in overlapping time periods.

The embodiments of the system described herein can take any number of forms including, but not limited to, mobile device, screen coupled to or located within a vehicle, virtual reality glasses, or the like. For example, in some embodiments, mobile devices can be smart watches, smart phones, tables or other devices that can receive information and therefore the devices can include an application that can be downloaded to provide the functionality of one or more of the embodiments described herein. Thus, in some embodiments, the system can be located at a vehicle and in other embodiments, one or more components of the system can be downloaded to a mobile device in possession of each or one or more travelers of the vehicle.

In some embodiments, the system can receive an input from a user of the system and/or a user of the user interface. The user can have the option to designate what multimedia content the user would like to see before beginning the tour and/or during the tour (e.g., like waterways, etc.). In some embodiments, the system can receive input re such preferences beforehand (e.g., at power on of the system and/or upon a user taking a seat in the vehicle or entering the vehicle generally). Accordingly in some embodiments, the system outputs only information or the type of information indicated as preferred by a user. Thus, one user may only see information about waterway locations of interest within proximity of the vehicle while another user on the same vehicle tour may see information about historical locations of interest within proximity of the vehicle. The system can selectively output different information, different forms of information or the like to different user interfaces associated with different users based on user preferences, age of user (e.g., the system can output information in cartoon form for a child while outputting similar information in documentary form to an output; the system can output information in braille or audio to a vision-impaired person while outputting in three-dimensions to a hearing impaired person). The options can be preset and selected by a user and/or selected by the system based on demographics of the user and/or can change from time to time.

In one or more of the various embodiments, the systems, methods or computer program products described herein can operate online in connection with a network (e.g., global positioning system, Internet or otherwise) or can operate offline such as by displaying and/or outputting multimedia content about a landmark or location of interest prestored in a database, memory or other storage device. The content can be displayed and/or output based on input at the system 100 controlling the system 100 to output the information as received from a user or other entity (machine, human, hardware, software or otherwise) in some embodiments. In various embodiments, the multimedia content can be accessed over a network or the multimedia content can be stored at the system, at device or system local to the vehicle at which the multimedia content is displayed or output and/or at the system/device coupled to the user interface. In some embodiments, an entity operating the vehicle can select the particular multimedia content to be displayed via the user interface(s) and such can be based on the location of the vehicle such that a tour can be provided to one or more inhabitants of the vehicle.

It is understood that the specific components (and measurements thereof) that are disclosed are mere examples. Based upon design preferences, it is understood that the components and/or processes can be rearranged, substituted and/or replaced for components or processes similar in structure and/or function while remaining within the scope of the present disclosure.

Those of skill would further appreciate that the various illustrative modules and functions described in connection with the embodiments disclosed herein can be implemented as electronic hardware, computer software, or combinations of both. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The previous description of the disclosed embodiments is provided to enable any person skilled in the art to make or use the present disclosure. Various modifications to these embodiments will be readily apparent to those skilled in the art, and the generic principles defined herein can be applied to other embodiments without departing from the spirit or scope of the disclosure. Thus, the present disclosure is not intended to be limited to the embodiments shown herein but is to be accorded the widest scope consistent with the principles and novel features disclosed herein.

While the specification describes particular examples of the present invention, those of ordinary skill can devise variations of the present invention without departing from the inventive concept. For example, the teachings herein refer to circuit-switched network elements but are equally applicable to packet-switched domain network elements.

The previous description of the disclosed examples is provided to enable any person skilled in the art to make or use the present invention. Various modifications to these examples will be readily apparent to those skilled in the art, and the generic principles defined herein can be applied to other examples without departing from the spirit or scope of the invention. Thus, the present invention is not intended to be limited to the examples shown herein but is to be accorded the widest scope consistent with the principles and novel features disclosed herein.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

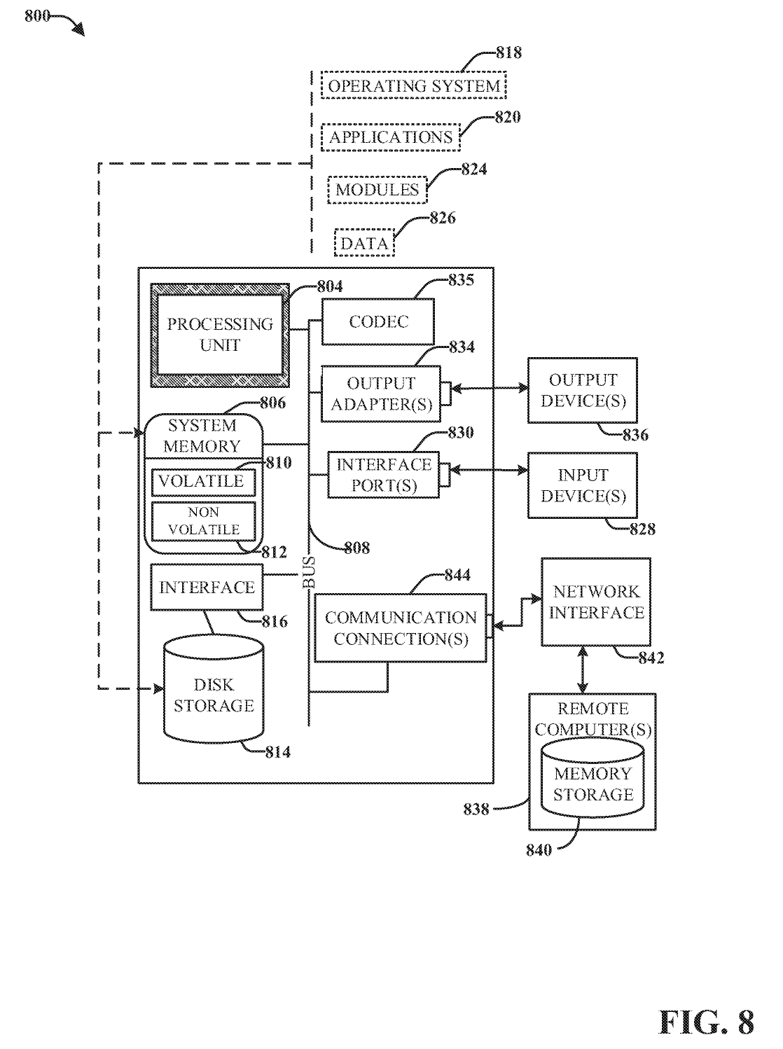

With reference to FIG. 8, a suitable environment 800 for implementing various aspects of the claimed subject matter includes a computer 802. The computer 802 includes a processing unit 804, a system memory 806, a codec 805, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 806 includes volatile memory 810 and non-volatile memory 812. The basic input/output system (BIOS), containing the basic routines to transfer information between elements within the computer 802, such as during start-up, is stored in non-volatile memory 812. In addition, according to present innovations, codec 805 may include at least one of an encoder or decoder, wherein the at least one of an encoder or decoder may consist of hardware, a combination of hardware and software, or software. Although, codec 805 is depicted as a separate component, codec 805 may be contained within non-volatile memory 812. By way of illustration, and not limitation, non-volatile memory 812 can include read only memory (ROM), programmable ROM (PROM), electrically programmable ROM (EPROM), electrically erasable programmable ROM (EEPROM), or flash memory. Volatile memory 810 includes random access memory (RAM), which acts as external cache memory. According to present aspects, the volatile memory may store the write operation retry logic (not shown in FIG. 8) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 802 may also include removable/non-removable, volatile/non-volatile computer storage medium. FIG. 8 illustrates, for example, disk storage 814. Disk storage 814 includes, but is not limited to, devices like a magnetic disk drive, solid state disk (SSD) floppy disk drive, tape drive, Jaz drive, Zip drive, LS-70 drive, flash memory card, or memory stick. In addition, disk storage 814 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 814 to the system bus 808, a removable or non-removable interface is typically used, such as interface 816.

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer system 802. Applications 820 take advantage of the management of resources by operating system 818 through program modules 824, and program data 826, such as the boot/shutdown transaction table and the like, stored either in system memory 806 or on disk storage 814. It is to be appreciated that the claimed subject matter can be implemented with various operating systems or combinations of operating systems.

A user enters commands or information into the computer 802 through input device(s) 828. Input devices 828 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 804 through the system bus 808 via interface port(s) 830. Interface port(s) 830 include, for example, a serial port, a parallel port, a game port, and a universal serial bus (USB). Output device(s) 836 use some of the same type of ports as input device(s). Thus, for example, a USB port may be used to provide input to computer 802, and to output information from computer 802 to an output device 836. Output adapter 834 is provided to illustrate that there are some output devices 836 like monitors, speakers, and printers, among other output devices 836, which require special adapters. The output adapters 834 include, by way of illustration and not limitation, video and sound cards that provide a means of connection between the output device 836 and the system bus 808. It should be noted that other devices and/or systems of devices provide both input and output capabilities such as remote computer(s) 838.

Computer 802 can operate in a networked environment using logical connections to one or more remote computers, such as remote computer(s) 838. The remote computer(s) 838 can be a personal computer, a server, a router, a network PC, a workstation, a microprocessor based appliance, a peer device, a smart phone, a tablet, or other network node, and typically includes many of the elements described relative to computer 802. For purposes of brevity, only a memory storage device 840 is illustrated with remote computer(s) 838. Remote computer(s) 838 is logically connected to computer 802 through a network interface 842 and then connected via communication connection(s) 844. Network interface 842 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 844 refers to the hardware/software employed to connect the network interface 842 to the bus 808. While communication connection 844 is shown for illustrative clarity inside computer 802, it can also be external to computer 802. The hardware/software necessary for connection to the network interface 842 includes, for exemplary purposes only, internal and external technologies such as, modems including regular telephone grade modems, cable modems and DSL modems, ISDN adapters, and wired and wireless Ethernet cards, hubs, and routers.

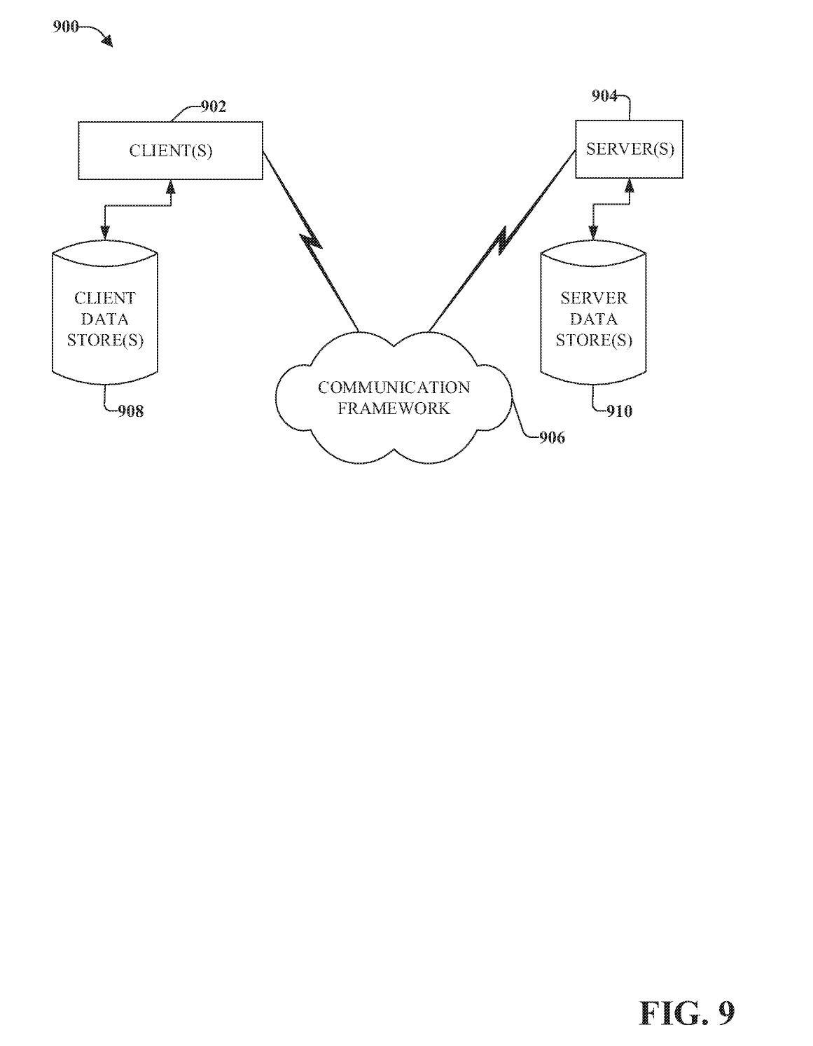

Referring now to FIG. 9, there is illustrated a schematic block diagram of a computing environment 900 in accordance with this disclosure. The system 900 includes one or more client(s) 902 (e.g., laptops, smart phones, PDAs, media players, computers, portable electronic devices, tablets, and the like). The client(s) 902 can be hardware and/or software (e.g., threads, processes, computing devices). The system 900 also includes one or more server(s) 904. The server(s) 904 can also be hardware or hardware in combination with software (e.g., threads, processes, computing devices). The servers 904 can house threads to perform transformations by employing aspects of this disclosure, for example. One possible communication between a client 902 and a server 904 can be in the form of a data packet transmitted between two or more computer processes wherein the data packet may include video data. The data packet can include a metadata, e.g., associated contextual information, for example. The system 900 includes a communication framework 906 (e.g., a global communication network such as the Internet, or mobile network(s)) that can be employed to facilitate communications between the client(s) 902 and the server(s) 904.

Communications can be facilitated via a wired (including optical fiber) and/or wireless technology. The client(s) 902 include or are operatively connected to one or more client data store(s) 908 that can be employed to store information local to the client(s) 902 (e.g., associated contextual information). Similarly, the server(s) 904 are operatively include or are operatively connected to one or more server data store(s) 910 that can be employed to store information local to the servers 904.

In one embodiment, a client 902 can transfer an encoded file, in accordance with the disclosed subject matter, to server 904. Server 904 can store the file, decode the file, or transmit the file to another client 902. It is to be appreciated, that a client 902 can also transfer uncompressed file to a server 904 and server 904 can compress the file in accordance with the disclosed subject matter. Likewise, server 904 can encode video information and transmit the information via communication framework 906 to one or more clients 902.

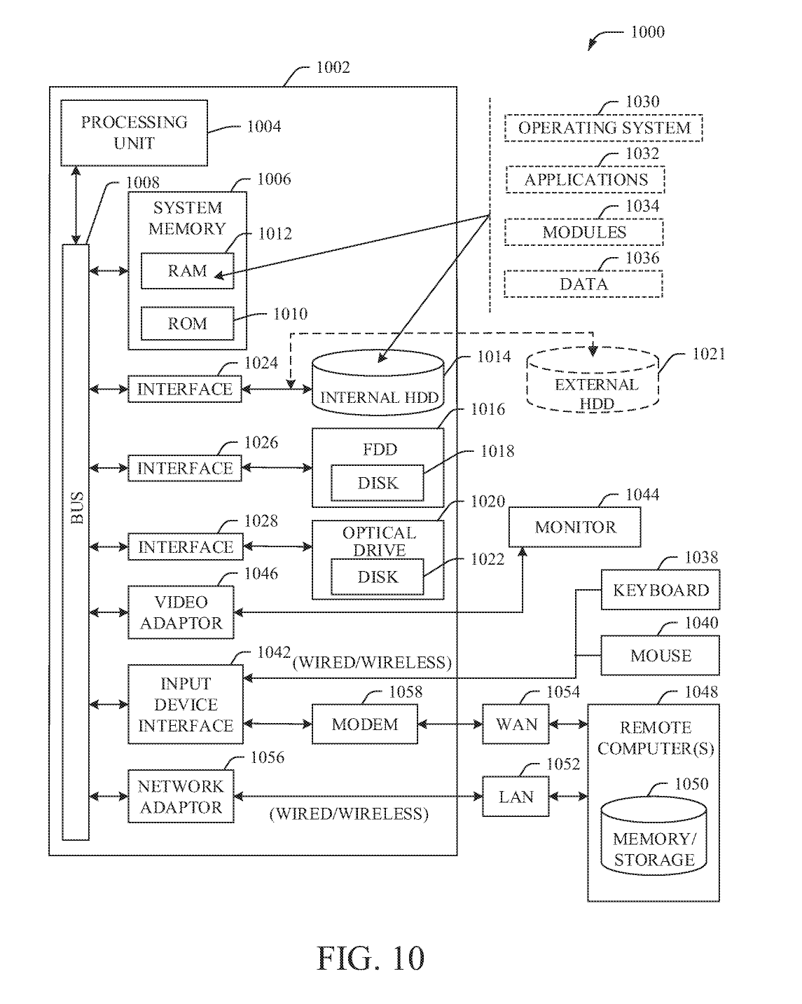

FIG. 10 illustrates a block diagram of a computer that can be employed in accordance with one or more embodiments. Repetitive description of like elements employed in other embodiments described herein is omitted for sake of brevity. In some embodiments, the computer, or a component of the computer, can be or be comprised within any number of components described herein comprising, but not limited to, management device 102, server devices 106, 108, first generation component 110, second generation component 120, devices 122, 124, interaction component 130, presentation component 140, navigation component 210 (or a component of management device 102, server devices 106, 108, first generation component 110, second generation component 120, devices 122, 124, interaction component 130, presentation component 140, navigation component 210). In order to provide additional text for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable (or machine-readable) storage media and/or communications media, which two terms are used herein differently from one another as follows. Computer-readable (or machine-readable) storage media can be any available storage media that can be accessed by the computer (or a machine, device or apparatus) and comprises both volatile and nonvolatile media, removable and non-removable media. By way of example, and not limitation, computer-readable (or machine-readable) storage media can be implemented in connection with any method or technology for storage of information such as computer-readable (or machine-readable) instructions, program modules, structured data or unstructured data. Tangible and/or non-transitory computer-readable (or machine-readable) storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable (or machine-readable) storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable (or machine-readable) media, is to be understood to exclude only propagating intangible signals per se as a modifier and does not relinquish coverage of all standard storage, memory or computer-readable (or machine-readable) media that are not only propagating intangible signals per se.

In this regard, the term “non-transitory” herein as applied to storage, memory or computer-readable (or machine-readable) media, is to be understood to exclude only propagating transitory signals per se as a modifier and does not relinquish coverage of all standard storage, memory or computer-readable (or machine-readable) media that are not only propagating transitory signals per se.

Communications media typically embody computer-readable (or machine-readable) instructions, data structures, program modules or other structured or unstructured data in a data signal such as a modulated data signal, e.g., a channel wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 10, the example environment 1000 for implementing various embodiments of the embodiments described herein comprises a computer 1002, the computer 1002 comprising a processing unit 1004, a system memory 1006 and a system bus 1008. The system bus 1008 couples system components comprising, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 comprises ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also comprise a high-speed RAM such as static RAM for caching data.

The computer 1002 further comprises an internal hard disk drive (HDD) 1010 (e.g., EIDE, SATA), which internal hard disk drive 1014 can also be configured for external use in a suitable chassis (not shown), a magnetic floppy disk drive 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface, respectively. The interface 1024 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable (or machine-readable) storage media provide nonvolatile storage of data, data structures, computer-executable instructions, and so forth. For the computer 1002, the drives and storage media accommodate the storage of any data in a suitable digital format. Although the description of computer-readable (or machine-readable) storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1012, comprising an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

A communication device can enter commands and information into the computer 1002 through one or more wired/wireless input devices, e.g., a keyboard 1038 and a pointing device, such as a mouse 1040. Other input devices (not shown) can comprise a microphone, an infrared (IR) remote control, a joystick, a game pad, a stylus pen, touch screen or the like. These and other input devices are often connected to the processing unit 1004 through an input device interface 1042 that can be coupled to the system bus 1008, but can be connected by other interfaces, such as a parallel port, an IEEE 1394 serial port, a game port, a universal serial bus (USB) port, an IR interface, etc.

A monitor 1044 or other type of display device can be also connected to the system bus 1008 via an interface, such as a video adapter 1046. In addition to the monitor 1044, a computer typically comprises other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically comprises many or all of the elements described relative to the computer 1002, although, for purposes of brevity, only a memory/storage device 1050 is illustrated. The logical connections depicted comprise wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1052 through a wired and/or wireless communication network interface or adapter 1056. The adapter 1056 can facilitate wired or wireless communication to the LAN 1052, which can also comprise a wireless AP disposed thereon for communicating with the wireless adapter 1056.

When used in a WAN networking environment, the computer 1002 can comprise a modem 1058 or can be connected to a communications server on the WAN 1054 or has other means for establishing communications over the WAN 1054, such as by way of the Internet. The modem 1058, which can be internal or external and a wired or wireless device, can be connected to the system bus 1008 via the input device interface 1042. In a networked environment, program modules depicted relative to the computer 1002 or portions thereof, can be stored in the remote memory/storage device 1050. It will be appreciated that the network connections shown are example and other means of establishing a communications link between the computers can be used.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a communication device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing communication device behavior, operator preferences, historical information, receiving extrinsic information). For example, SVMs can be configured via a learning or training phase within a classifier constructor and feature selection module. Thus, the classifier(s) can be used to automatically learn and perform a number of functions, comprising but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of communication device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable (or machine-readable) storage media, described herein can be either volatile memory or nonvolatile memory or can comprise both volatile and nonvolatile memory.

Memory disclosed herein can comprise volatile memory or nonvolatile memory or can comprise both volatile and nonvolatile memory. By way of illustration, and not limitation, nonvolatile memory can comprise read only memory (ROM), programmable ROM (PROM), electrically programmable ROM (EPROM), electrically erasable PROM (EEPROM) or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above comprises mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “comprises” is used in either the detailed description or the claims, such term is intended to be inclusive in a manner similar to the term “comprising” as “comprising” is interpreted when employed as a transitional word in a claim.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system comprising:
a memory that has stored thereon computer executable components; and
a processor that executes the following computer executable components stored in the memory:
a first generation component configured to generate a first set of multimedia content corresponding to a first location of a vehicle;
a second generation component configured to generate a second set of multimedia content corresponding to a second location of the vehicle;
an interaction component configured to facilitate generation of detailed information associated with a first subset of multimedia content of the first set of multimedia content or a second subset of multimedia content of the second set of multimedia content based on a set of received input data; and
a presentation component configured to display the first set of multimedia content, the second set of multimedia content, the first subset of multimedia content or the second subset of multimedia content at a user interface.

2. The system of claim 1, further comprising a navigation component configured to generate the first subset of multimedia content or the second set of multimedia content based on global positioning coordinates of the vehicle, wherein the navigation component interacts with and receives information from a vehicle map navigation tool.

3. The system of claim 2, further comprising a triggering component configured to automatically present the first set of multimedia content or the second set of multimedia content based on the vehicle proximity to a point of interest.

4. The system of claim 3, further comprising a determination component configured to determine the vehicle proximity to the point of interest based on the global positioning coordinates.

5. The system of claim 1, wherein the first set of multimedia content or the second set of multimedia content comprises at least one of audio content, image content, or video content.

6. The system of claim 3, wherein the point of interest comprises at least one of a waterway, a river, a landmark, a monument, a historical event, or an identified terrain.

7. The system of claim 1, wherein the vehicle is an airplane.

8. The system of claim 1, wherein the vehicle is a train.

9. The system of claim 1, wherein the vehicle is a boat.

10. The system of claim 1, wherein the vehicle is at least one of a bus or a car.

11. The system of claim 1, wherein the user interface is coupled to at least one of a mobile device, a tablet device or the vehicle.

12. The system of claim 1, wherein the first subset of multimedia content or the second subset of multimedia content is detailed information about the point of interest.

13. The system of claim 12, wherein the detailed information comprises at least one of an image of the point of interest, a photograph of the point of interest, textual information about the point of interest, video information about the point of interest or audio information about the point of interest.

14. A computer-implemented method comprising:
generating, by a system comprising a processor, a first set of multimedia content corresponding to a historical or natural landmark of interest within a defined proximity to a location of a vehicle; and
displaying, by a user interface of the system, the first set of multimedia content, wherein the displaying comprises outputting video of images and textual details regarding the historical or natural landmark of interest, and wherein the displaying is output during a time period overlapping with a second time period during which the location of the vehicle is within the defined proximity to the historical or natural landmark of interest.

15. The computer-implemented method of claim 14, further comprising:
receiving, by the system, global positioning coordinates of the location of the vehicle;
identifying, by the system, the historical or natural landmark of interest; and
generating, by the system, the first set of multimedia content based on the location of the vehicle.

16. The computer-implemented method of claim 15, further comprising:
generating, by the device, information indicative of instructions to enable the vehicle to navigate to a second historical or natural landmark of interest based on a determination by the system that the historical or natural landmark of interest is associated with the second historical or natural landmark of interest.

17. The computer-implemented method of claim 15, further comprising:
generating, by the device, information indicative of instructions to enable the vehicle to navigate to a second historical or natural landmark of interest based on a determination by the system that the historical or natural landmark of interest has been determined to be related based on an input of a user.

18. A machine-readable storage medium, comprising executable instructions that, when executed by a processor, facilitate performance of operations, comprising:
generating a first set of multimedia content corresponding to a first location of a vehicle;
generating a second set of multimedia content corresponding to a second location of the vehicle;
facilitating generation of detailed information associated with a first subset of multimedia content of the first set of multimedia content or a second subset of multimedia content of the second set of multimedia content based on a set of received input data; and
displaying the first set of multimedia content, the second set of multimedia content, the first subset of multimedia content or the second subset of multimedia content at a user interface.

19. The machine-readable storage medium of claim 18, wherein the displaying comprising providing tactile display via the user interface.

20. The machine-readable storage medium of claim 18, wherein the vehicle comprises an airplane.
